(19) United States
(12) Patent Application Publication
(10) Pub. No.: US 2017/0171741 A1
(43) Pub. Date: Jun. 15, 2017

(54) REMOTE DISABLING OF A MOBILE DEVICE

(71) Applicant: Driving Management Systems, Inc., San Francisco, CA (US)

(72) Inventor: Marwan Hannon, San Francisco, CA (US)

(21) Appl. No.: 15/116,863

(22) PCT Filed: Feb. 6, 2015
(86) PCT No.: PCT/US2015/014835

§ 371 Date: Aug. 5, 2016

Related U.S. Application Data
(60) Provisional application No. 61/937,277, filed on Feb. 7, 2014.

(51) Int. Cl. H04W 8/24; H04W 4/02

(52) U.S. Cl. CPC H04W 8/245; H04W 4/02

(57) ABSTRACT

A method for remotely controlling a mobile device includes receiving, at a mobile device, a personal code, where the personal code includes information to cause the mobile device to implement an action according to a function of the mobile device and implementing the action, by the mobile device, in accordance with the personal code, upon receiving the personal code, where implementing the action comprises at least one of disabling at least one feature of the mobile device, erasing at least a portion of information on the mobile device, or resetting the mobile device.

This application claims priority to U.S. Provisional Application Ser. No. 61/937,277, which was filed on Feb. 7, 2014, the entirety of which is incorporated herein by reference.

### BACKGROUND

There is a growing problem with stolen smartphones in both the United States and worldwide. For example, in San Francisco, almost half of all crime involves a stolen smartphone. Wireless companies have been slow to implement carrier-side policies and systems to prevent smartphone or other mobile device theft. Thus, there is a need for systems and methods for remotely controlling mobile devices to discourage theft and provide avenues for recovering stolen devices.

### FIGURES

FIG. 1 is a flowchart of a method for remotely controlling a mobile device according to an embodiment of the present disclosure.

FIG. 2 is a flowchart of a method for remotely controlling a mobile device according to an embodiment of the present disclosure.

FIG. 3 is a logic diagram illustrating one technique for remotely controlling a mobile device based on a plurality of received codes.

FIG. 4 is a logic diagram illustrating one technique for remotely disabling a mobile device.

FIG. 5 shows a schematic view of an illustrative electronic device.

FIG. 6 shows one embodiment of an input/output subsystem for an electronic device.

FIG. 7 shows one embodiment of a communications interface for an electronic device.

FIG. 8 shows one embodiment of a memory subsystem for an electronic device.

### SUMMARY

As disclosed herein, a method for remotely controlling a mobile device comprises receiving, at a mobile device, a personal code, wherein the personal code comprises information to cause the mobile device to implement an action according to a function of the mobile device and implementing the action, by the mobile device, in accordance with the personal code, upon receiving the personal code. Implementing the action may comprise at least one of disabling at least one feature of the mobile device, erasing at least a portion of information on the mobile device, or resetting the mobile device.

Additionally, as disclosed herein, a method for remotely controlling a mobile device comprises receiving, by a mobile device a plurality of location coordinates, storing the plurality of location coordinates, receiving, at a mobile device, a personal code, wherein the personal code comprises information to cause the mobile device to implement an action according to a function of the mobile device, implementing the action, by the mobile device, in accordance with the personal code, upon receiving the personal code, and transmitting the plurality of location coordinates upon receiving the personal code. Implementing the action comprises at least one of disabling at least one feature of the mobile device, erasing at least a portion of information on the mobile device, or resetting the mobile device.

According to embodiments of the present disclosure, storing the plurality of location coordinates comprises storing the plurality of location coordinates for a predetermined period of time and erasing at least a portion of the plurality of location coordinates upon expiration of the predetermined period of time.

According to embodiments of the present disclosure, the mobile device may be a first mobile device, and receiving, at the mobile device, the personal code comprises receiving the personal code from a second mobile device.

According to embodiments of the present disclosure, a method further comprises initiating at least one additional task after implementing the action by the mobile device.

According to embodiments of the present disclosure, a method further comprises receiving, at the mobile device, a communication call and wherein the receiving of the personal code comprises receiving the personal code during the communication call.

According to embodiments of the present disclosure, receiving the personal code comprises receiving the personal code in a text message received at the mobile device.

According to embodiments of the present disclosure, implementing the action comprises disabling at least one feature of the mobile device, and wherein the disabling the at least one feature of the mobile device comprises turning off the mobile device.

According to embodiments of the present disclosure, the method further comprises capturing, by the mobile device, identifying information via a camera of the mobile device upon receiving the personal code.

According to embodiments of the present disclosure, a method further comprises emitting, by the mobile device, an alarm by the mobile device upon receiving the personal code.

According to embodiments of the present disclosure, a method further comprises activating, by the mobile device, a tracking function upon receiving the personal code.

According to embodiments of the present disclosure, activating the tracking function comprises transmitting a location of the mobile device.

According to embodiments of the present disclosure, a method further comprises transmitting at least a portion of the information stored on the mobile device upon receiving the personal code.

According to embodiments of the present disclosure, transmitting of at least a portion of the information stored on the mobile device comprises transmitting at least a portion of the information to a network server of a local service provider.

According to embodiments of the present disclosure, implementing the action comprises erasing at least a portion of information on the mobile device, and further comprising erasing at least a portion of personal data stored on the mobile device upon receiving the personal code.

In addition, as disclosed herein, a device for remotely disabling a mobile device comprises a mobile device configured to receive, at the mobile device, a personal code, wherein the personal code comprises information to cause the mobile device to implement an action according to a function of the mobile device and implement the action, by the mobile device, in accordance with the personal code upon receiving the personal code. The action comprises at least one of disabling at least one feature of the mobile device, erasing at least a portion of information on the mobile device, or resetting the mobile device.

According to embodiments of the present disclosure, the mobile device is a first mobile device, and wherein the first mobile device is configured to receive the personal code from a second mobile device.

According to embodiments of the present disclosure, the mobile device is configured to initiate at least one additional task after disabling the at least one feature of the mobile device.

According to embodiments of the present disclosure, the mobile device is configured to receive, at the mobile device, a communication call and receive the personal code during the communication call.

According to embodiments of the present disclosure, the mobile device is configured to receive the personal code in a text message received at the mobile device.

According to embodiments of the present disclosure, the mobile device is configured to shutdown upon receiving the personal code.

According to embodiments of the present disclosure, the mobile device is configured to capture identifying information via a camera of the mobile device upon receiving the personal code.

According to embodiments of the present disclosure, the mobile device is configured to emit an alarm using at least one function of the mobile device upon receiving the personal code.

According to embodiments of the present disclosure, the mobile device is configured to activate a tracking function upon receiving the personal code.

According to embodiments of the present disclosure, the mobile device is configured to transmit a location of the mobile device.

According to embodiments of the present disclosure, the mobile device is configured to transmit at least a portion of information stored on the mobile device upon receiving the personal code.

According to embodiments of the present disclosure, the mobile device is configured to transmit at least a portion of the information to a network server of a local service provider.

According to embodiments of the present disclosure, the mobile device is configured to erasing at least a portion of information stored on the mobile device upon receiving the personal code and wherein the information stored on the mobile device comprises personal data stored on the mobile device.

According to embodiments of the present disclosure, the mobile device is configured to transmit the personal data to a network server of a local service provider.

According to embodiments of the present disclosure, the mobile device is configured to receive a plurality of location coordinates, store the plurality of location coordinates, and transmit the plurality of location coordinates upon receiving the personal code.

According to embodiments of the present disclosure, the mobile device is configured to store the plurality of location coordinates for a predetermined period of time and erase at least a portion of the plurality of location coordinates upon expiration of the predetermined period of time.

### DESCRIPTION

In embodiments of the present disclosure, apparatus, systems and methods are disclosed for remotely controlling a mobile device. In one embodiment, a mobile device comprises a processor and a memory for storing machine executable instructions that when executed by the processor enable the processor to remotely control the mobile device according to methods disclosed herein.

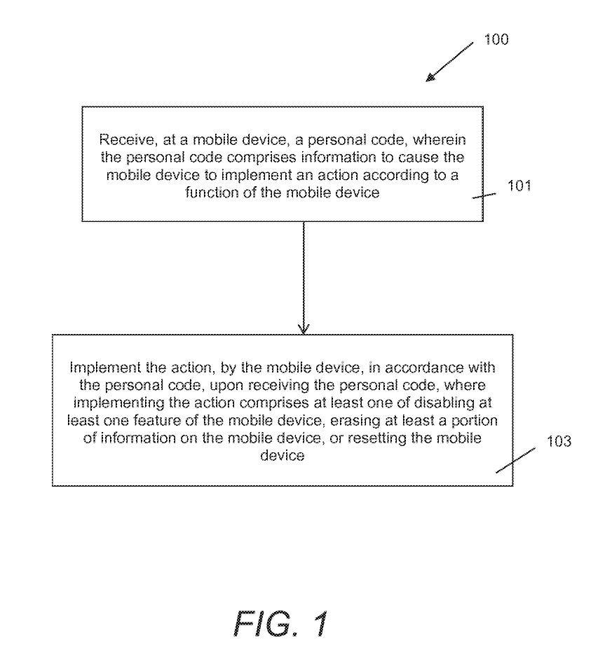

As shown in FIG. 1, a method 100 for remotely controlling a mobile device comprises receiving 101, at a mobile device, a personal code. The personal code comprises information to cause the mobile device to implement an action according to a function of the mobile device. The method 100 further comprises implementing 103 the action, by the mobile device, in accordance with the personal code, upon receiving the personal code. Implementing the action comprises at least one of disabling at least one feature of the mobile device, erasing at least a portion of information on the mobile device, or resetting the mobile device. Accordingly, the mobile device may reset to factory settings, delete specifically identified information, and/or completely wipe a memory of the mobile device. In some embodiments, the mobile device deletes information stored in memory if it detects an attempt to circumvent the screen lock, such as, for example, removal of the battery, repeat resets, connection to a desktop computer, and/or any other suitable indication of tampering.

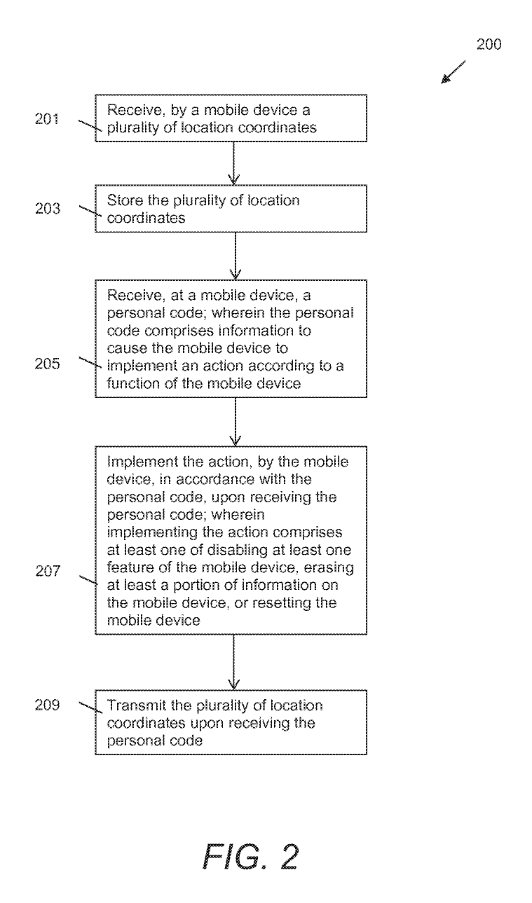

In another embodiment of the present disclosure shown in FIG. 2, a method 200 for remotely controlling a mobile device comprises receiving, by a mobile device, a plurality of location coordinates 201 and storing the plurality of coordinates 203. According to embodiments of the present disclosure, the plurality of coordinates may be stored in a non-transitory memory device of the mobile device or in another memory storage device. The method 200 further comprises receiving, at a mobile device, a personal code 205, implementing the action, by the mobile device, in accordance with the personal code, upon receiving the personal code 207, and transmitting the plurality of location coordinates upon receiving the personal code 209. Implementing the action comprises at least one of disabling at least one feature of the mobile device, erasing at least a portion of information on the mobile device, or resetting at least one function the mobile device.

The personal code may comprise information to cause the mobile device to implement an action according to a function of the mobile device. The personal code may be received from a second mobile device and the second mobile device may be operated by the owner of the first mobile device. Additionally, the personal code may be received during a communication call received at the mobile device. For instance, the owner of the mobile device may call the number of the mobile device and when the call is connected, either through a voice connection or a connection to a voice messaging system for example, the owner is able to input a number corresponding to the personal code. The personal code may then be transmitted to the mobile device. In addition, the personal code may be received in a text message received at the mobile device. Furthermore, in the event that the mobile device is out of range of a network for a period of time, for example, based on the mobile device being turned off or running out of power, the personal code may be received by the mobile device upon subsequent activation of the mobile device.

Further, in embodiments of the methods 100, 200, the method may further comprise capturing, by the mobile device, identifying information via a camera of the mobile device upon receiving the personal code. Identifying information may include a photograph of the individual that has possession of the mobile device at that time or the surroundings of the location of the mobile device. Identifying information may include information that is taken in by a sensor of the mobile device, such as for example, a fingerprint.

In embodiments of the methods 100, 200, at least one additional task may be initiated after implementing the action by the mobile device. Additional tasks may include transmitting information stored on the mobile device, disabling additional features of the mobile, erasing additional information on the mobile device, activating at least one feature of the mobile device, and resetting additional functions of the mobile device. Disabling the at least one feature of the mobile device may comprise turning off the mobile device or at least one function of the mobile device.

In addition, the methods 100, 200, may further comprise emitting, by the mobile device, an alarm by the mobile device upon receiving the personal code. The alarm may be an audible and/or visual effect that will alert individuals within proximity to the mobile device that mobile device was stolen. For instance, a flashing light and/or a siren may be activated.

The methods 100, 200, may also further comprise activating, by the mobile device, a tracking function upon receiving the personal code. Activating the tracking function may comprise transmitting a location of the mobile device. The location of the mobile device may be a current location of the mobile device and it may include GPS coordinates, triangulated coordinates of a cellular system, or any other information that provides location identification of a mobile device.

Additionally, the methods 100, 200, may further comprise transmitting at least a portion of the information stored on the mobile device upon receiving the personal code. Transmitting of at least a portion of the information stored on the mobile device may comprise transmitting at least a portion of the information to a network server of a local service provider. The information stored on the mobile device may include any type of data that would be important or valuable to the owner of the mobile device. For instance, as a non-exhaustive list, the information may include personal and non-personal data. Personal data may include sensitive information to the owner of the phone, such as for example, contacts, calendars, photographs, call logs, text messages, and similar information. Non-personal data may include information that is not sensitive information but is nonetheless important to the owner of the mobile device, such as mobile applications and associated data, electronic documents, and similar information. Furthermore, implementing the action may comprise erasing at least a portion of information on the mobile device and erasing at least a portion of information on the mobile device comprises erasing at least a portion of personal data stored on the mobile device upon receiving the personal code.

In another embodiment of the present disclosure, a device for remotely disabling a mobile device comprises a mobile device configured to receive, at the mobile device, a personal code, where the personal code comprises information to cause the mobile device to implement an action according to a function of the mobile device, and implement the action, by the mobile device, in accordance with the personal code upon receiving the personal code. The action comprises at least one of disabling at least one feature of the mobile device, erasing at least a portion of information on the mobile device, or resetting the mobile device. Additionally, in embodiments, the mobile device may comprise any or all of the functions described above with regard to methods 100 and 200.

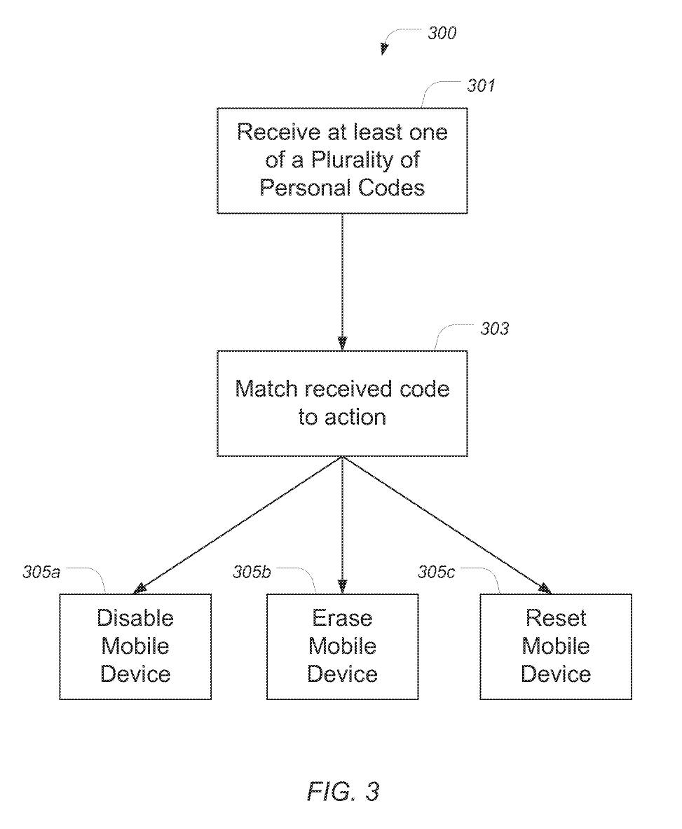

FIG. 3 is a logic diagram illustrating a technique 300 for remotely controlling a mobile device based on a plurality of received codes. In some embodiments, the mobile device receives 301 at least one of a plurality of codes from a mobile device owner. The mobile device matches 303 the received code(s) to one or more actions that can be taken by the mobile device. The mobile device initiates one or more actions in response to the received code(s), such as, for example, disabling 305a the mobile device, erasing 305b the mobile device, and/or resetting 305c the mobile device. In some embodiments, the mobile device is configured to receive a plurality of personal codes from the subscriber. The plurality of personal codes may correspond to a plurality of actions that can be taken by a mobile device, including implementing the “Kill-IT” method as discussed in more detail below. According to embodiments, a first personal code disables the mobile device and a second personal code causes the mobile device to erase at least a portion of information stored in memory of the mobile device. For example, the mobile device may reset to factory settings, delete specifically identified information, or completely wipe the memory of the mobile device. In some embodiments, the mobile device deletes information stored in memory if it detects an attempt to circumvent the screen lock, such as, for example, removal of the battery, repeat resets, connection to a desktop computer, and/or any other suitable indication of tampering.

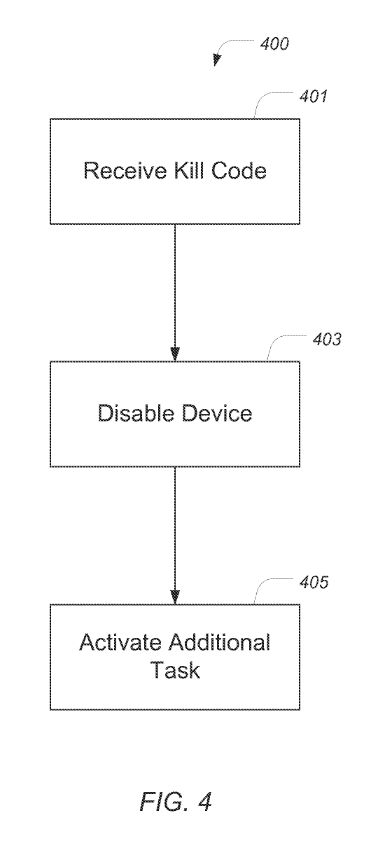

In another embodiment, a mobile device comprises a processor and a memory for storing machine executable instructions that when executed by the processor enable the processor to remotely disable the mobile device. This process is referred to herein as “Kill-IT” or a “Kill-IT” method. The Kill-IT method empowers subscribers to control and disable mobile devices without the intervention or cooperation of wireless provides. The “Kill-IT” method allows a user to directly interact with a lost and/or stolen mobile device comprising any communication capabilities to disable the mobile device. FIG. 4 is a logic diagram illustrating one technique 400 for remotely disabling a mobile device. As illustrated in FIG. 4, in one embodiment, a mobile device is configured to receive at least one of a plurality of personal codes 401. The personal codes may be sent directly or indirectly from a mobile device owner. The mobile device is configured to disable the mobile device after it receives 403 the personal code. In some embodiments, the mobile device may initiate 405 one or more additional tasks after disabling the device.

As described more particularly herein, in various embodiments, the “Kill-IT” method provides several functional embodiments. In one embodiment, a subscriber (also referred to as an owner of a mobile device) can call their mobile device and enter a personal code to “Kill” the mobile device. In another embodiment, a subscriber can text their mobile device and enter a personal code to “Kill-IT” the mobile device if the mobile device is turned off. Once the device is turned on, the command would take effect. In another embodiment, once the “Kill-IT” method is activated, it would not only disable the mobile device, but could take a picture of the perpetrator and email it to the victim for a police report or posting on social media once the mobile device is powered on. In another embodiment, the mobile device with the “Kill-IT” method is configured to erase all of the information on the mobile device to prevent personal information from falling into the wrong hands. In one embodiment, the mobile device with a GPS or other location function with the “Kill-IT” method is configured to enable tracking of the mobile device by law enforcement or other persons while the mobile device is disabled. A mobile device equipped with the “Kill-IT” method may include any one of the features, attributes, and/or functions described in these embodiments either alone or combined in any combination.

In some embodiments, the mobile device is configured to receive voice calls. For example, the mobile device may be coupled to a wireless carrier network, such as, for example, AT&T, Verizon, T-Mobile, Vodaphone, or any other suitable wireless carrier configured to provide mobile voice communications. As another example, the mobile device may implement a voice-over-IP (VOIP) protocol to send and/or receive voice communications over a data network, such as, for example, a local area network (LAN), a wide-area network (WAN) (such as the Internet), or any other suitable data network.

The subscriber associated with the mobile device is able to call the mobile device, using, for example, the wireless network or VOIP protocol. After establishing a connection with the mobile device, the subscriber enters a personal code to “kill” or disable the mobile device. The personal code may be entered in any suitable manner, such as, for example, a voice code, a numeric tonal code input through a touch-tone pad, and/or any other suitable entry manner.

In embodiments, the mobile device is configured to receive data messages, such as, for example, short message service (SMS) messages, Google chat (G-chat) messages, Blackberry Messenger (BBM) messages, and/or any other suitable data messaging service. The subscriber associated with the mobile device sends a message, for example, a text message, to the mobile device using one or more messaging services. The text message contains a personal code. When the mobile device receives the message with the personal code, the mobile device “kills” or disables the mobile device. In some embodiments, data messages, such as, for example, text messages, are delivered to mobile devices when the mobile device is turned on. Therefore, a subscriber may send a data message to the mobile device which will be delivered when the device is turned on, disabling the device from further use.

In some embodiments, the “Kill-IT” method implements one or more additional tasks when activated by the subscriber, for example, through a phone call or a data message containing a personal code. In one embodiment, the “Kill-IT” method disables the mobile device to prevent use of the mobile device and further activates one or more sensors of the mobile device, such as, for example, a camera, a microphone, a global positioning system (GPS) locator, and/or any other suitable sensor. The “Kill-IT” method gathers information, for example, by taking a photograph using the mobile devices camera. The mobile device may provide the gathered information to the user, law enforcement, and/or any other suitable party to assist in locating the mobile device.

In certain embodiments, after receiving a personal code, for example, through a voice call or data message, the mobile device activates a GPS locator. The mobile device may activate the GPS locator and disable all other functions of the mobile device, allowing a subscriber and/or law enforcement to track and locate the position of the mobile device. In embodiments, one or more alternative and/or additional location services may be activated by the mobile device. For example, in one embodiment, the mobile device activates a location system based on nearby wireless networks and/or access points. As another example, in one embodiment, the mobile device activates a location system based on one or more internal sensors, such as, for example, accelerometers, gyroscopes, and/or any other suitable sensor.

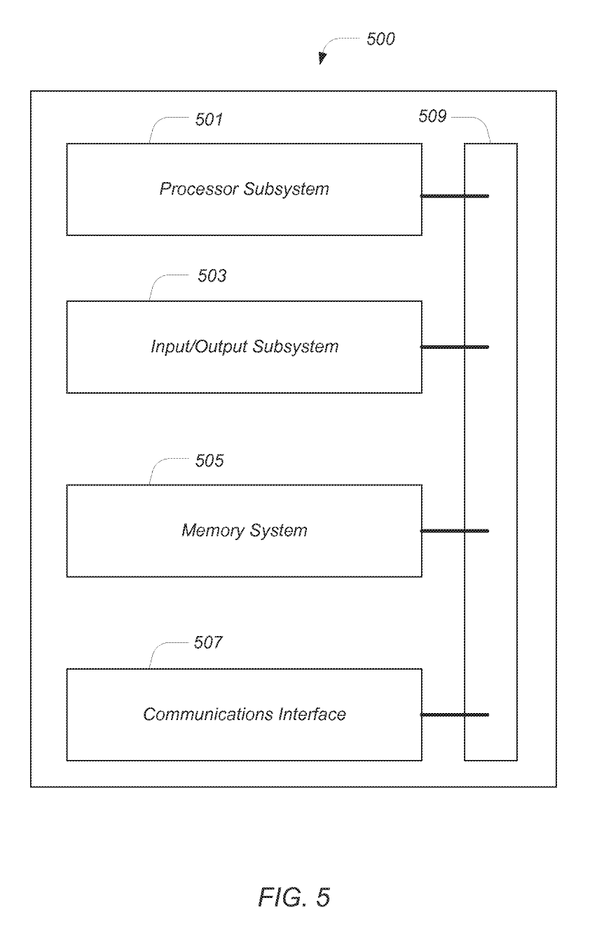

Turning now to FIG. 5, FIG. 5 is a schematic view of an illustrative electronic device 500 capable of implementing the system and method of remotely disabling a mobile device. Electronic device 500 may comprise a processor subsystem 501, an input/output subsystem 503, a memory subsystem 505, a communications interface 507, and a system bus 509. In some embodiment, one or more than one of the electronic device 500 components may be combined or omitted such as, for example, not including the communications interface 507. In embodiments, the electronic device 500 may comprise other components not combined or comprised in those shown in FIG. 5. For example, the electronic device 500 also may comprise a power subsystem. In other embodiments, the electronic device 500 may comprise several instances of the components shown in FIG. 5. For example, the electronic device 500 may comprise multiple memory subsystems 505. For the sake of conciseness and clarity, and not limitation, one of each of the components is shown in FIG. 5.

The processor subsystem 501 may comprise any processing circuitry operative to control the operations and performance of the electronic device 500. In various embodiments, the processor subsystem 501 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 501 also may be implemented by a controller, a microcontroller, an application specific integrated circuit (ASIC), a field programmable gate array (FPGA), a programmable logic device (PLD), and so forth.

In various embodiments, the processor subsystem 501 may be arranged to run an operating system (OS) and various mobile applications. Examples of an OS comprise, for example, operating systems generally known under the trade name of Apple OS, Microsoft Windows OS, Android OS, and any other proprietary or open source OS. Examples of mobile applications comprise, for example, a telephone application, a camera (e.g., digital camera, video camera) application, a browser application, a multimedia player application, a gaming application, a messaging application (e.g., email, short message, multimedia), a viewer application, and so forth.

In some embodiments, the electronic device 500 may comprise a system bus 509 that couples various system components including the processing subsystem 501, the input/output subsystem 503, and the memory subsystem 505. The system bus 509 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications.

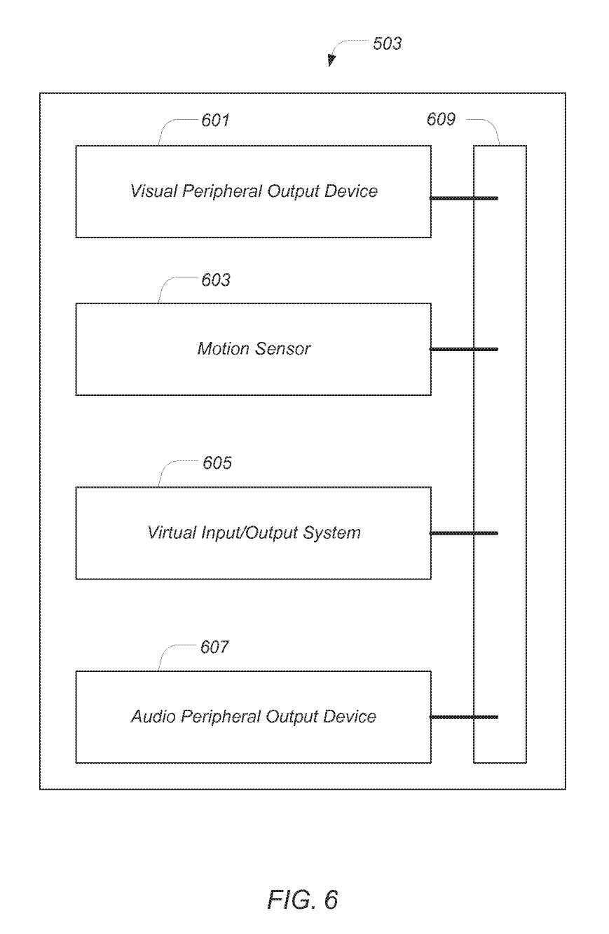

FIG. 6 shows one embodiment of the input/output subsystem 503 of the electronic device 500 shown in FIG. 5. The input/output subsystem 503 may comprise any suitable mechanism or component to at least enable a user to provide input to the electronic device 500 and the electronic device 500 to provide output to the user. For example, the input/output subsystem 503 may comprise any suitable input mechanism, including but not limited to, a button, keypad, keyboard, click wheel, touch screen, or motion sensor. In some embodiments, the input/output subsystem 503 may comprise a capacitive sensing mechanism, or a multi-touch capacitive sensing mechanism. Descriptions of capacitive sensing mechanisms can be found in U.S. Patent Application Publication No. 2006/0026521, entitled GESTURES FOR TOUCH SENSITIVE INPUT DEVICE and U.S. Patent Publication No. 2006/0026535, entitled MODE-BASED GRAPHICAL USER INTERFACES FOR TOUCH SENSITIVE INPUT DEVICE, both of which are incorporated by reference herein in their entirety. It will be appreciated that any of the input mechanisms described herein may be implemented as physical mechanical components, virtual elements, and/or combinations thereof.

In some embodiments, the input/output subsystem 503 may comprise specialized output circuitry associated with output devices such as, for example, an audio peripheral output device 607. The audio peripheral output device 607 may comprise an audio output including on or more speakers integrated into the electronic device. The speakers may be, for example, mono or stereo speakers. The audio peripheral output device 607 also may comprise an audio component remotely coupled to audio peripheral output device 607 such as, for example, a headset, headphones, and/or ear buds which may be coupled to the audio peripheral output device 607 through the communications subsystem 507.

In some embodiments, the input/output subsystem 503 may comprise a visual peripheral output device 601 for providing a display visible to the user. For example, the visual peripheral output device 601 may comprise a screen such as, for example, a Liquid Crystal Display (LCD) screen, incorporated into the electronic device 500. As another example, the visual peripheral output device 601 may comprise a movable display or projecting system for providing a display of content on a surface remote from the electronic device 500. In some embodiments, the visual peripheral output device 601 can comprise a coder/decoder, also known as a Codec, to convert digital media data into analog signals. For example, the visual peripheral output device 601 may comprise video Codecs, audio Codecs, or any other suitable type of Codec.

The visual peripheral output device 601 also may comprise display drivers, circuitry for driving display drivers, or both. The visual peripheral output device 601 may be operative to display content under the direction of the processor subsystem 501. For example, the visual peripheral output device 601 may be able to play media playback information, application screens for application implemented on the electronic device 500, information regarding ongoing communications operations, information regarding incoming communications requests, or device operation screens, to name only a few.

In some embodiments, the input/output subsystem 503 may comprise a motion sensor 603. The motion sensor 603 may comprise any suitable motion sensor operative to detect movements of electronic device 500. For example, the motion sensor 603 may be operative to detect acceleration or deceleration of the electronic device 500 as manipulated by a user. In some embodiments, the motion sensor 603 may comprise one or more three-axis acceleration motion sensors (e.g., an accelerometer) operative to detect linear acceleration in three directions (i.e., the x or left/right direction, the y or up/down direction, and the z or forward/backward direction). As another example, the motion sensor 603 may comprise one or more two-axis acceleration motion sensors which may be operative to detect linear acceleration only along each of x or left/right and y or up/down directions (or any other pair of directions). In some embodiments, the motion sensor 603 may comprise an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

In some embodiments, the motion sensor 603 may be operative to directly detect rotation, rotational movement, angular displacement, tilt, position, orientation, motion along a non-linear (e.g., arcuate) path, or any other non-linear motions. For example, when the motion sensor 603 is a linear motion sensor, additional processing may be used to indirectly detect some or all of the non-linear motions. For example, by comparing the linear output of the motion sensor 603 with a gravity vector (i.e., a static acceleration), the motion sensor 603 may be operative to calculate the tilt of the electronic device 500 with respect to the y-axis. In some embodiments, the motion sensor 603 may instead or in addition comprise one or more gyro-motion sensors or gyroscopes for detecting rotational movement. For example, the motion sensor 603 may comprise a rotating or vibrating element.

In some embodiments, the motion sensor 603 may comprise one or more controllers (not shown) coupled to the accelerometers or gyroscopes. The controllers may be used to calculate a moving vector of the electronic device 500. The moving vector maybe determined according to one or more predetermined formulas based on the movement data (e.g., x, y, and z axis moving information) provided by the accelerometers or gyroscopes.

In some embodiments, the input/output subsystem 503 may comprise a virtual input/output system 605. The virtual input/output system 605 is capable of providing input/output options by combining one or more input/output components to create a virtual input type. For example, the virtual input/output system 605 may enable a user to input information through an on-screen keyboard which utilizes the touch screen and mimics the operation of a physical keyboard or using the motion sensor 603 to control a pointer on the screen instead of utilizing the touch screen. As another example, the virtual input/output system 605 may enable alternative methods of input and output to enable use of the device by persons having various disabilities. For example, the virtual input/output system 605 may convert on-screen text to spoken words to enable reading-impaired persons to operate the device.

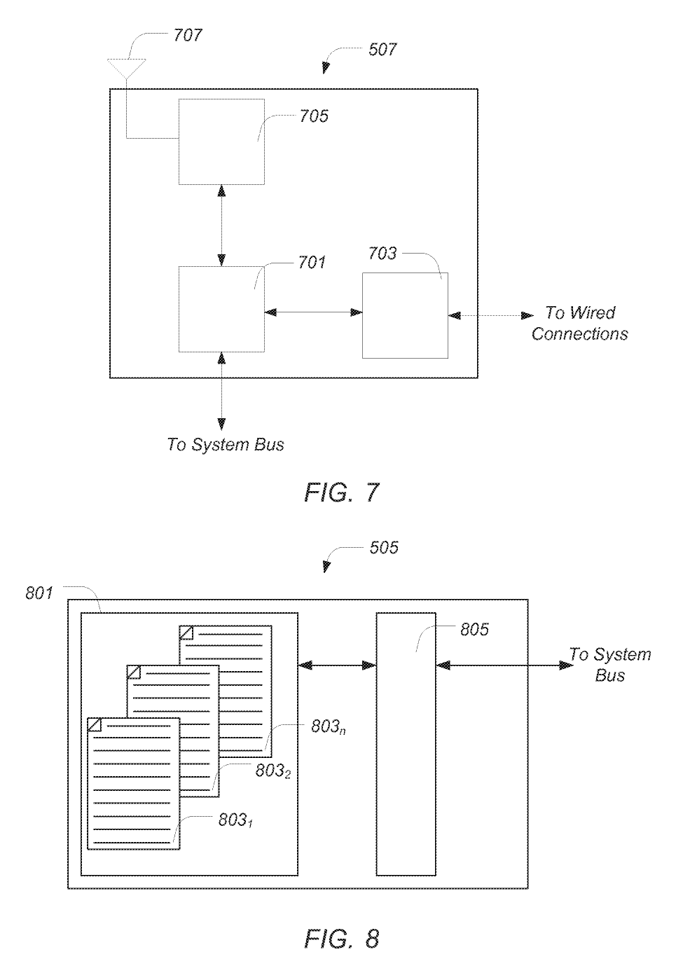

FIG. 7 shows embodiments of the communication interface 507. The communications interface 507 may comprises any suitable hardware, software, or combination of hardware and software that is capable of coupling the electronic device 500 to one or more networks and/or devices. The communications interface 507 may be arranged to operate with any suitable technique for controlling information signals using a desired set of communications protocols, services or operating procedures. The communications interface 507 may comprise the appropriate physical connectors to connect with a corresponding communications medium, whether wired or wireless.

Vehicles of communication comprise a network. In various embodiments, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various embodiments, the communications interface 507 may comprise one or more interfaces such as, for example, a wireless communications interface 705, a wired communications interface 703, a network interface 701, a transmit interface, a receive interface, a media interface, a system interface, a component interface, a switching interface, a chip interface, a controller, and so forth. When implemented by a wireless device or within wireless system, for example, the communications interface 507 may comprise a wireless interface 705 comprising one or more antennas 707, transmitters, receivers, transceivers, amplifiers, filters, control logic, and so forth.

In various embodiments, the communications interface 507 may provide voice and/or data communications functionality in accordance with different types of cellular radiotelephone systems. In various implementations, the described embodiments may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In various implementations, the described embodiments may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

FIG. 8 shows one embodiment of the memory subsystem 505. The memory subsystem 505 may comprise any machine-readable or computer-readable media capable of storing data, including both volatile/non-volatile memory and removable/non-removable memory. The memory subsystem 505 may comprise at least one non-volatile memory unit 801. The non-volatile memory unit 801 is capable of storing one or more software programs 803₁-803ₙ. The software programs 803₁-803ₙ may contain, for example, applications, user data, device data, and/or configuration data, or combinations therefore, to name only a few. The software programs 803₁-803ₙ may contain instructions executable by the various components of the electronic device 500.

In various embodiments, the memory subsystem 505 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some embodiments, the memory subsystem 505 may contain a software program for remotely disabling the mobile computing device 500. In one embodiment, the memory subsystem 505 may contain an instruction set, in the form of a file 803ₙ for executing a method of remotely disabling the mobile computing device. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 501.

Examples of handheld mobile devices suitable for implementing the system and method of remotely disabling a mobile computing device comprise, but are not limited to: the Apple iPhone™ and iPod™; RIM Blackberry® Curve™, Pearl™, Storm™, and Bold™; Hewlett Packard Veer; Palm® (now HP) Pixi™, Pre™; Google Nexus S™, Motorola DEFY™, Droid (generations 1-3), Droid X, Droid X2, Flipside™, Atrix™, and Citrus™; HTC Incredible™, Inspire™, Surround™, EVO™, G2™, HD7, Sensation™, Thunderbolt™, and Trophy™; LG Fathom™, Optimus T™, Phoenix™, Quantum™, Revolution™, Rumor Touch™, and Vortex™; Nokia Astound™; Samsung Captivate™, Continuum™, Dart™, Droid Charge™, Exhibit™, Epic™, Fascinate™, Focus™, Galaxy S™, Gravity™, Infuse™, Replenish™, Seek™, and Vibrant™; Pantech Crossover; T-Mobile® G2™, Comet™, myTouch™; Sidekick®; Sanyo Zio™; Sony Ericsson Xperia™ Play.

Examples of tablet computing devices suitable for implementing the system and method of remotely disabling a mobile computing device comprise, but are not limited to: Acer Iconia Tab A500, the Apple iPad™ (1 and 2), Asus Eee Pad Transformer, Asus Eee Slate, Coby Kyros, Dell Streak, Hewlett Packard TouchPad, Motorola XOOM, Samsung Galaxy Tab, Archos 101 internet tablet, Archos 9 PC tablet, Blackberry PlayBook, Hewlett Packard Slate, Notion ink Adam, Toshiba Thrive, and the Viewsonic Viewpad.

In some embodiments, the “Kill-IT” method may be combined with one or more additional mobile device control methods. Additional methods and systems that may be combined with the “Kill-IT” application are disclosed in U.S. Pat. App. Pub. Nos. 2011/0183601 and 2012/0055726, the disclosures of which are incorporated by reference herein in their entireties.

In various embodiments, as referred to herein a mobile device may be implemented as a handheld portable device, computing device, computer, mobile telephone, sometimes referred to as a smartphone, tablet personal computer (PC), kiosk, desktop computer, or laptop computer, or any combination thereof. Examples of smartphones include, for example, an iPhone®, an iPod®, an iPad®, a device operating the Android operating system (“OS”) from Google Inc., a device running the Microsoft Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, or another similar type of mobile computing device having a capability to communicate with clients and the host system via a communications network. Computing devices may include a suitable browser software application (e.g., Internet Explorer, Internet Explorer Mobile, Chrome, Safari, Firefox, Blazer, etc.) for enabling the user to display and interact with information exchanged via a communication network.

Although some embodiments of the mobile device may be described with a mobile or fixed computing device implemented as a smart phone, personal digital assistant, laptop, desktop computer by way of example, it may be appreciated that the embodiments are not limited in this context. For example, a mobile computing device may comprise, or be implemented as, any type of wireless device, mobile station, or portable computing device with a self-contained power source (e.g., battery) such as the laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communication device, and so forth. Additional mobile devices include, for example, wearable mobile devices such as, for example, wearable health monitors produced by BodyMedia, JawBone, FitBit, along with devices like the Apple® Watch and Google® Glass.

In various embodiments, the mobile device may provide voice and/or data communications functionality in accordance with different types of cellular radiotelephone systems. Examples of cellular radiotelephone systems may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, 3G systems such as Wide-band CDMA (WCDMA), CDMA-2000, Universal Mobile Telephone System (UMTS) systems, WiMAX (Worldwide Interoperability for Microwave Access, LTE (Long Term Evolution) and so forth.

In various embodiments, the mobile device may be configured to provide voice and/or data communications functionality in accordance with different types of wireless network systems or protocols. Examples of suitable wireless network systems offering data communication services may include the Institute of Electrical and Electronics Engineers (IEEE) 802.xx series of protocols, such as the IEEE 802.1a/b/g/n series of standard protocols and variants (also referred to as “WiFi”), the IEEE 802.16 series of standard protocols and variants (also referred to as “WiMAX”), the IEEE 802.20 series of standard protocols and variants, and so forth. The mobile computing device 700 may also utilize different types of shorter range wireless systems, such as a Bluetooth system operating in accordance with the Bluetooth Special Interest Group (SIG) series of protocols, including Bluetooth Specification versions v1.0, v1.1, v1.2, v1.0, v2.0 with Enhanced Data Rate (EDR), as well as one or more Bluetooth Profiles, and so forth. Other examples may include systems using infrared techniques or near-field communication techniques and protocols, such as electromagnetic induction (EMI) techniques. An example of EMI techniques may include passive or active radio-frequency identification (RFID) protocols and devices.

In various embodiments, the interface device is configured to couple to a communication interface to access the cloud (Internet). The communication interface may form part of a wired communications system, a wireless communications system, or a combination of both. For example, the mobile device 302 may be configured to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The mobile device may be arranged to communicate information over one or more types of wireless communication links such as a radio channel, satellite channel, television channel, broadcast channel infrared channel, radio-frequency (RF) channel, WiFi channel, a portion of the RF spectrum, and/or one or more licensed or license-free frequency bands. In wireless implementations, the mobile device may comprise one more interfaces and/or components for wireless communication such as one or more transmitters, receivers, transceivers, amplifiers, filters, control logic, wireless network interface cards (WNICs), antennas, and so forth.

Broad categories of previously discussed mobile devices include, for example, personal communication devices, handheld devices, and mobile telephones. In various aspects, a mobile device may refer to a handheld portable device, computer, mobile telephone, smartphone, tablet personal computer (PC), laptop computer, and the like, or any combination thereof. Examples of smartphones include any high-end mobile phone built on a mobile computing platform, with more advanced computing ability and connectivity than a contemporary feature phone. Some smartphones mainly combine the functions of a personal

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several embodiments without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment of the present disclosure. The appearances of the phrase “in one embodiment” or “in one embodiment” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, embodiments, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary embodiments and embodiments shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as when it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

Various embodiments are described in the following numbered clauses:
1. A method for remotely controlling a mobile device comprising:

receiving, at a mobile device, a personal code, wherein the personal code comprises information to cause the mobile device to implement an action according to a function of the mobile device; and

implementing the action, by the mobile device, in accordance with the personal code, upon receiving the personal code; and

wherein implementing the action comprises at least one of disabling at least one feature of the mobile device, erasing at least a portion of information on the mobile device, or resetting the mobile device.
2. The method of clause 1, wherein the mobile device is a first mobile device, and wherein the receiving, at the mobile device, the personal code comprises receiving the personal code from a second mobile device.
3. The method of clause 1, further comprising initiating at least one additional task after implementing the action by the mobile device.
4. The method of any of clauses 1 through 3, further comprising receiving, at the mobile device, a communication call and wherein the receiving of the personal code comprises receiving the personal code during the communication call.
5. The method of any of clauses 1 through 3, wherein the receiving of the personal code comprises receiving the personal code in a text message received at the mobile device.
6. The method of any of clauses 1 through 3, wherein implementing the action comprises disabling at least one feature of the mobile device, and wherein the disabling the at least one feature of the mobile device comprises turning off the mobile device.
7. The method of any of clauses 1 through 3, further comprising capturing, by the mobile device, identifying information via a camera of the mobile device upon receiving the personal code.
8. The method of any of clauses 1 through 3, further comprising emitting, by the mobile device, an alarm by the mobile device upon receiving the personal code.
9. The method of any of clauses 1 through 3, further comprising activating, by the mobile device, a tracking function upon receiving the personal code.
10. The method of clause 9, wherein the activating the tracking function comprises transmitting a location of the mobile device.
11. The method of any of clauses 1 through 3, further comprising transmitting at least a portion of the information stored on the mobile device upon receiving the personal code.
12. The method of clause 11, wherein the transmitting of at least a portion of the information stored on the mobile device comprises transmitting at least a portion of the information to a network server of a local service provider.
13. The method of any of clauses 1 through 3, wherein implementing the action comprises erasing at least a portion of information on the mobile device and wherein erasing at least a portion of information on the mobile device comprises erasing at least a portion of personal data stored on the mobile device upon receiving the personal code.
14. A method for remotely disabling a mobile device comprising:

receiving, by a mobile device a plurality of location coordinates;

storing the plurality of location coordinates;

receiving, at a mobile device, a personal code, wherein the personal code comprises information to cause the mobile device to implement an action according to a function of the mobile device;

implementing the action, by the mobile device, in accordance with the personal code, upon receiving the personal code; and

transmitting the plurality of location coordinates upon receiving the personal code; and

wherein implementing the action comprises at least one of disabling at least one feature of the mobile device, erasing at least a portion of information on the mobile device, or resetting the mobile device.
15. The method of clause 14, wherein the storing the plurality of location coordinates comprises storing the plurality of location coordinates for a predetermined period of time and erasing at least a portion of the plurality of location coordinates upon expiration of the predetermined period of time.
16. The method of clause 14, wherein the mobile device is a first mobile device and wherein the receiving, at the mobile device, the personal code comprises receiving the personal code from a second mobile device.
17. The method of any of clauses 14 through 16, further comprising initiating at least one additional task after implementing the action by the mobile device.
18. The method of any of clauses 14 through 16, further comprising receiving, at the mobile device, a communication call and wherein the receiving the personal code comprises receiving the personal code during the communication call.
19. The method of any of clauses 14 through 16, wherein the receiving the personal code comprises receiving the personal code in a text message received at the mobile device.
20. The method of any of clauses 14 through 16, wherein implementing the action comprises disabling at least one feature of the mobile device, and wherein the disabling the at least one feature of the mobile device comprises turning off the mobile device.
21. The method of any of clauses 14 through 16, further comprising capturing, by the mobile device, identifying information via a camera of the mobile device upon receiving the personal code.
22. The method of any of clauses 14 through 16, further comprising emitting, by the mobile device, an alarm by the mobile device upon receiving the personal code.
23. The method of any of clauses 14 through 16, further comprising activating, by the mobile device, a tracking function upon receiving the personal code.
24. The method of clause 23, wherein the activating the tracking function comprises transmitting a location of the mobile device.
25. The method of any of clauses 14 through 16, further comprising transmitting at least a portion of the information stored on the mobile device upon receiving the personal code.
26. The method of clause 25, wherein the transmitting of at least a portion of the information stored on the mobile device comprises transmitting at least a portion of the information to a network server of a local service provider.
27. The method of any of clauses 14 through 16, wherein implementing the action comprises erasing at least a portion of information on the mobile device and erasing at least a portion of information on the mobile device comprises erasing at least a portion of personal data stored on the mobile device upon receiving the personal code.
28. A device for remotely disabling a mobile device comprising:

a mobile device configured to:
receive, at the mobile device, a personal code, wherein the personal code comprises information to cause the mobile device to implement an action according to a function of the mobile device; and
implement the action, by the mobile device, in accordance with the personal code upon receiving the personal code; and
wherein the action comprises at least one of disabling at least one feature of the mobile device, erasing at least a portion of information on the mobile device, or resetting the mobile device.
29. The device of clause 28, wherein the mobile device is a first mobile device, and wherein the first mobile device is configured to receive the personal code from a second mobile device.
30. The device of any of clause 28, wherein the mobile device is configured to initiate at least one additional task after disabling the at least one feature of the mobile device.
31. The device of any of clauses 28 through 30, wherein the mobile device is configured to receive, at the mobile device, a communication call and receive the personal code during the communication call.
32. The device of any of clauses 28 through 30, wherein the mobile device is configured to receive the personal code in a text message received at the mobile device.
33. The device of any of clauses 28 through 30, wherein the mobile device is configured to shutdown upon receiving the personal code.
34. The device of any of clauses 28 through 30, wherein the mobile device is configured to capture identifying information via a camera of the mobile device upon receiving the personal code.
35. The device of any of clauses 28 through 30, wherein the mobile device is configured to emit an alarm using at least one function of the mobile device upon receiving the personal code.
36. The device of any of clauses 28 through 30, wherein the mobile device is configured to activate a tracking function upon receiving the personal code.
37. The device of clause 36, wherein the mobile device is configured to transmit a location of the mobile device.
38. The device of any of clauses 28 through 30, wherein the mobile device is configured to transmit at least a portion of information stored on the mobile device upon receiving the personal code.
39. The device of clause 38, wherein the mobile device is configured to transmit at least a portion of the information to a network server of a local service provider.
40. The device of any of clauses 28 through 30, wherein the mobile device is configured to erasing at least a portion of information stored on the mobile device upon receiving the personal code and wherein the information stored on the mobile device comprises personal data stored on the mobile device.
41. The device of clause 40, wherein the mobile device is configured to transmit the personal data to a network server of a local service provider.
42. The device of any of clauses 28 through 30, wherein the mobile device is configured to:

receive a plurality of location coordinates;

store the plurality of location coordinates;

transmit the plurality of location coordinates upon receiving the personal code.
43. The method of clause 40, wherein the mobile device is configured to store the plurality of location coordinates for a predetermined period of time and erase at least a portion of the plurality of location coordinates upon expiration of the predetermined period of time.

1. A method for remotely controlling a mobile device comprising:
receiving, at a mobile device, a personal code, wherein the personal code comprises information to cause the mobile device to implement an action according to a function of the mobile device; and
implementing the action, by the mobile device, in accordance with the personal code, upon receiving the personal code;
wherein implementing the action comprises disabling a feature of the mobile device.

2. The method of claim 1, wherein the mobile device is a first mobile device, and wherein the receiving, at the mobile device, the personal code comprises receiving the personal code from a second mobile device.

3-5. (canceled)

6. The method of claim 1, wherein disabling the feature of the mobile device comprises turning off the mobile device.

7. The method of claim 1, further comprising capturing, by the mobile device, identifying information via a camera of the mobile device upon receiving the personal code.

8. The method of claim 1, further comprising emitting, by the mobile device, an alarm by the mobile device upon receiving the personal code.

9. The method of claim 1, further comprising activating, by the mobile device, a tracking function upon receiving the personal code and transmitting a location of the mobile device.

10-12. (canceled)

13. The method of claim 44, wherein erasing the portion of information on the mobile device comprises erasing a portion of personal data stored on the mobile device upon receiving the personal code.

14. A method for remotely disabling a mobile device comprising:
receiving, by a mobile device a plurality of location coordinates;
storing the plurality of location coordinates;
receiving, at a mobile device, a personal code, wherein the personal code comprises information to cause the mobile device to implement an action according to a function of the mobile device;
implementing the action, by the mobile device, in accordance with the personal code, upon receiving the personal code; and
transmitting the plurality of location coordinates upon receiving the personal code;
wherein implementing the action comprises disabling a feature of the mobile device.

15. (canceled)

16. The method of claim 14, wherein the mobile device is a first mobile device and wherein the receiving, at the mobile device, the personal code comprises receiving the personal code from a second mobile device.

17-19. (canceled)

20. The method of claim 14, wherein the disabling the feature of the mobile device comprises turning off the mobile device.

21. The method of claim 14, further comprising capturing, by the mobile device, identifying information via a camera of the mobile device upon receiving the personal code.

22. The method of claim 14, further comprising emitting, by the mobile device, an alarm by the mobile device upon receiving the personal code.

23-26. (canceled)

27. The method of claim 46, wherein erasing the portion of information on the mobile device comprises erasing a portion of personal data stored on the mobile device upon receiving the personal code.

28. A device for remotely disabling a mobile device comprising:
a mobile device configured to:
receive, at the mobile device, a personal code, wherein the personal code comprises information to cause the mobile device to implement an action according to a function of the mobile device; and
implement the action, by the mobile device, in accordance with the personal code upon receiving the personal code; and
wherein the action comprises disabling at least one feature of the mobile device.

29. The device of claim 28, wherein the mobile device is a first mobile device, and wherein the first mobile device is configured to receive the personal code from a second mobile device.

30-32. (canceled)

33. The device of claim 28, wherein the mobile device is configured to shutdown upon receiving the personal code.

34. The device of claim 28, wherein the mobile device is configured to capture identifying information via a camera of the mobile device upon receiving the personal code.

35. The device of claim 28, wherein the mobile device is configured to emit an alarm using a function of the mobile device upon receiving the personal code.

36. The device of claim 28, wherein the mobile device is configured to activate a tracking function upon receiving the personal code and to transmit a location of the mobile device.

37-39. (canceled)

40. The device of claim 28, wherein the mobile device is configured to erase a portion of information stored on the mobile device upon receiving the personal code and wherein the information stored on the mobile device comprises personal data stored on the mobile device.

41-43. (canceled)

44. The method of claim 1, wherein implementing the action comprises erasing a portion of information of the mobile device.

45. The method of claim 1, wherein implementing the action comprises resetting the mobile device.

46. The method of claim 14, wherein implementing the action comprises erasing a portion of information on the mobile device.

47. The method of claim 14, wherein implementing the action comprises resetting the mobile device.

48. The method of claim 28, wherein implementing the action comprises erasing a portion of information on the mobile device.

49. The method of claim 28, wherein implementing the action comprises resetting the mobile device.
